(19) United States
(12) Patent Application Publication
(10) Pub. No.: US 2013/0333780 A1
(43) Pub. Date: Dec. 19, 2013

(54) WATER SUPPLY BASE OF A PLANT POT

(71) Applicant: Tien-Yin CHAN, Tainan City (TW)

(72) Inventor: Tien-Yin CHAN, Tainan City (TW)

(21) Appl. No.: 13/526,986

(22) Filed: Jun. 19, 2012

(51) Int. Cl. F03B 11/02

(52) U.S. Cl. 137/561 R

(57) ABSTRACT

The present invention is a water supply base of a plant pot, including a body, the body is provided with a holding space to contain liquid and is provided with a platform to emplace the plant pot; and a porous rod, the porous rod is extended into the holding space and is protruded out of the platform. By the capillary action of the porous rod, water that is stored in the holding space is supplied to soil in the plant pot, allowing plant in the plant pot to receive the required water continuously.

### BACKGROUND OF THE INVENTION

a) Field of the Invention

The present invention relates to a water supply base of a plant pot, and more particularly to water supply base of a plant pot, wherein the water supply base is provided with a holding space to contain liquid and liquid is supplied to soil in the plant pot through a porous rod.

b) Description of the Prior Art

Bonsai is able to increase greenery, suitable for landscaping and viewing. However, plant will be withered if water is not supplied for a long time; on the other hand, if too much water is supplied, water will easily escape or be accumulated in a water pan at a bottom of the plant pot, forming a hot bed for mosquito media. The Taiwan Utility Model Patent, No. M402603, “Water Pan and Plant Pot,” discloses a water pan and a plant pot, including a pan which is provided with a pan surface and a wall rim protruding along a periphery of the pan surface, with that a water-holding space is formed between the pan surface and the wall rim and the pan surface is provided with a fixing member; a porous rod which is assembled on the fixing member; and a pot which is assembled on the pan surface of the pan and maintains a gap from the pan surface, with that a bottom of the pan is provided with a through-hole sheathed with the porous rod, an interior of the pan is formed with a containing space and the through-hole is connected to the containing space. A user can put the porous rod upright on the fixing member, penetrating the porous rod through the through-hole to extend into the containing space. Next, soil and bonsai are planted into the containing space of the pot; and then, excessive water used for sprinkling the bonsai is recovered by the pan and reused by the capillary action of the porous rod, achieving an effect of saving water.

Nevertheless, the abovementioned patent exists with following shortcomings:

1. The excessive water for sprinkling the bonsai is recovered by the pan. But as the pan takes water in an open way, mosquito medial can be easily bred.

2. The pan takes water in the open way; therefore, water can easily volatile by high ambient temperature and cannot be totally used for the bonsai.

3. The excessive water that is used to sprinkle the bonsai can overflow from the pan, causing water to be accumulated on a ground or a desktop.

Additionally, the Taiwan Utility Model Patent, No. M401979, “Moisture-Retaining Plant Pot,” discloses a moisture-retaining plant pot. The moisture-retaining plant pot is provided with a watertight outer pot and an interior of the outer pot is provided with a first space. An interior of the first space is also inserted with a watertight inner pot and a proper gap is kept between the inner pot and the outer pot to contain water. An interior of the inner pot is provided with a second space to contain plant and dirt. A wall of the inner pot is penetrated with at least one through-hole. The through-hole is inserted with a porous conductor which is protruded into the first space and the second space, keeping dirt humid for a long time by the capillary action resulted from the porous conductor. Besides, the Taiwan Utility Model Patent, No. M369027, “Plant Pot Reminding of Sprinkling Using a Moisture Sensitive Material,” discloses a plant pot that reminds of sprinkling using a moisture sensitive material. The plant pot includes an outer pot which is a watertight vessel, with that a wall of the outer pot is filled with a moisture sensitive material; and an inner pot which is made by a porous material and is put inside the outer pot, with that an eave of the inner pot is provided with a water flooding hole. Through the moisture sensitive material on the outer pot, water content of the porous inner pot can be aware of to remind a user of sprinkling the plant, thereby adjusting water of the plant in the plant pot.

The abovementioned patents M401979 and M369027 have to fit with the inner pot of a fixed shape and size to achieve the expected effect, unable to be applied to a general plant pot.

### SUMMARY OF THE INVENTION

The primary object of the present invention is to provide a water supply base which is provided with a non-open water-holding space and is able to be applied to most plant pots. In addition, the water supply base of the present invention can maintain soil in the plant pot at a proper humidity, avoiding a trouble for sprinkling the plant constantly. The water supply base of a plant pot, according to the present invention, includes a body which is provided with a non-open holding space to contain liquid, with that a platform is provided on the body to emplace the plant pot; and a porous rod which is extended into the holding space and is protruded out of the platform.

The abovementioned porous rod is integrally formed with the body.

The abovementioned body is provided with a through-hole and a diameter of the through-hole is a little larger than that of the porous rod to transfix the porous rod.

The aforementioned porous rod is hollow or solid.

The aforementioned holding space is provided with a fixing seat to fix the porous rod.

The aforementioned body is further provided with a water flooding hole and a plane height of the water flooding hole is lower than that of the platform.

The body is further provided with a water level indication unit that is connected with the holding space. The water level indication unit includes an outer tube that is connected with the holding space, and a ball that is located inside the outer tube.

The abovementioned porous rod is transversally extended with a resist portion at a location where the porous rod is protruded out of the platform.

The present invention is provided with following advantages:
1. The present invention does not need to fit with the plant pot or vessel of a specific size, as long as that a bottom of the plant pot or vessel is provided with a round hole. The plant is supplied with water through the porous rod, wherein the porous rod supplies water by the capillary action, which is able to constantly keep soil of the bonsai at a moderate humidity.
2.The holding space of the present invention is a non-open design; therefore, mosquito media will not be bred easily.
3.The holding space of the present invention is the non-open design; therefore, water inside the plant pot will not evaporate easily and the bonsai can be supplied with water for a longer time.
4. The porous rod of the present invention is transversally extended with the resist portion at the location where the porous rod is protruded out of the platform. The resist portion can be abutted at a bottom of an inner rim of the plant pot and when the plant pot is lifted up, the porous rod can be prevented from being entrained upward by soil and then falling out while being entrained.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of structures of a first embodiment of the present invention combining with a plant pot.

FIG. 2 shows a cutaway view of the first embodiment of the present invention combining with a plant pot.

FIG. 3 shows a state view of implementation of the first embodiment of the present invention combining with a plant pot, disclosing that the ball will be at a higher point when water is sufficient.

FIG. 4 shows a state view of implementation of the first embodiment of the present invention combining with a plant pot, disclosing that the ball will descend when water is insufficient.

FIG. 5 shows a schematic view of implementation of a second embodiment of the present invention combining with a plant pot, disclosing that the fixing seat can fix the porous rod.

FIG. 6 shows a schematic view of implementation of a third embodiment of the present invention combining with a plant pot, disclosing a configuration that the porous rod is assembled with the body.

### DETAILED DESCRIPTION OF THE PREFERRED EMBODIMENTS

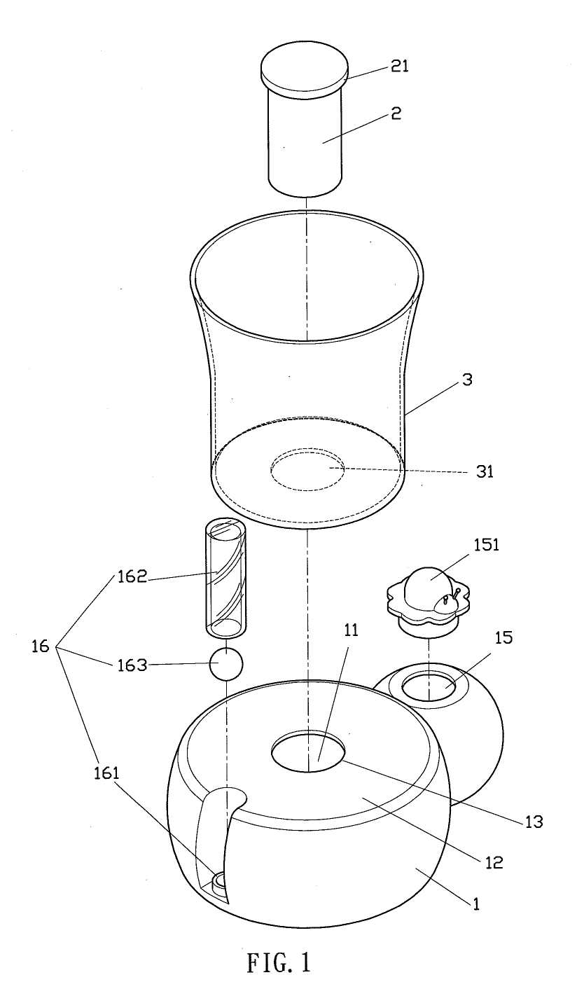

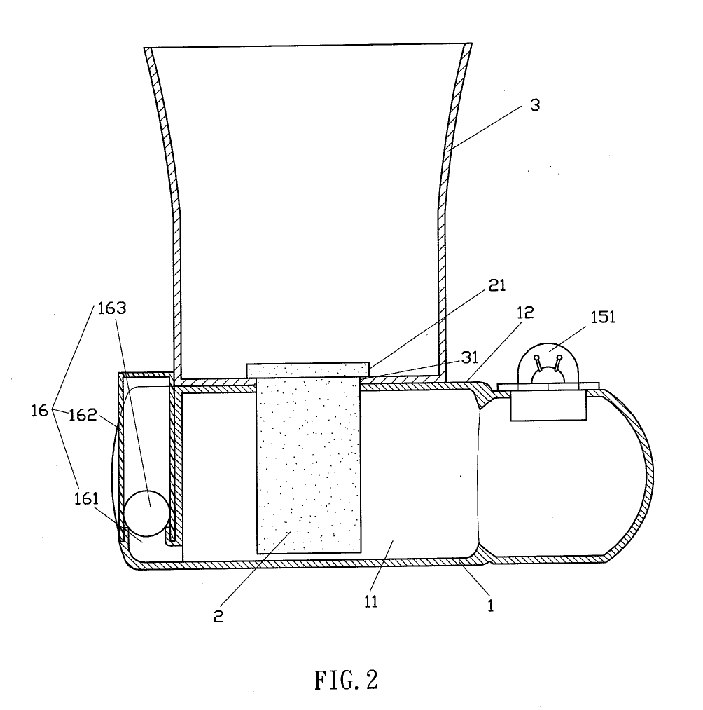

Referring to FIG. 1 and FIG. 2, a first embodiment of the present invention comprises a body 1 and a porous rod 2. The first embodiment is further described in association with a plant pot 3. The body 1 includes a non-open holding space 11 to store water or nutrition liquid with fertilizer. The so-called non-open holding space means that the holding space 11 can be roughly formed with a sealed state through shielding or covering by other elements. The body 1 is provided with a platform 12 to emplace the plant pot 3. In the first embodiment, the platform 12 is provided with a through-hole 13.

In the first embodiment, the porous rod 2 is solid and a top end of the porous rod 2 is provided with a circular resist portion 21 that is protruded radially. The resist portion 21 is used to prohibit the porous rod 2 from penetrating through a round hole 31 at a bottom of the plant pot 3, thereby forming a limiting function. The porous rod 2 passes through the round hole 31 at the bottom of the plant pot 3 and the through-hole 13 of the body 1, extending into the holding space 11.

The abovementioned body 1 further includes a water flooding hole 15 and a cover 151 to seal the water flooding hole 15, so that a user can add water conveniently from the water flooding hole 15 into the holding space 11 and seal the water flooding hole 15 with the cover 151 after adding the water. A plane height of the water flooding hole 15 is a little lower than that of the platform 12, so that a condition of adding water can be watched from the water flooding hole 15, preventing from adding too much water that the water will overflow from the through-hole 13. The body 1 is provided in advance with an assembling port 161 for installing a water level indication unit 16. The water level indication unit 16 includes an outer tube 162 and a ball 163. The abovementioned assembling port 161 is connected to the holding space 11 of the body 1; whereas, the outer tube 162 is a transparent tube with a sealed top end and is tightly installed at the assembling port 161. A joining place between the outer tube 162 and the assembling port 161 is provided with a leak-proof washer, is pasted with silicon, or is treated with other known leak-proof methods to prevent water from leaking out. The top end of the outer tube 162 can be provided additionally with tiny air vents (not shown in the drawings) to maintain balance between inner and outer pressure of the outer tube 162. An interior of the outer tube 162 holds the ball 163 and the ball 163 is preferably of explicit color to show the water level in the holding space 11.

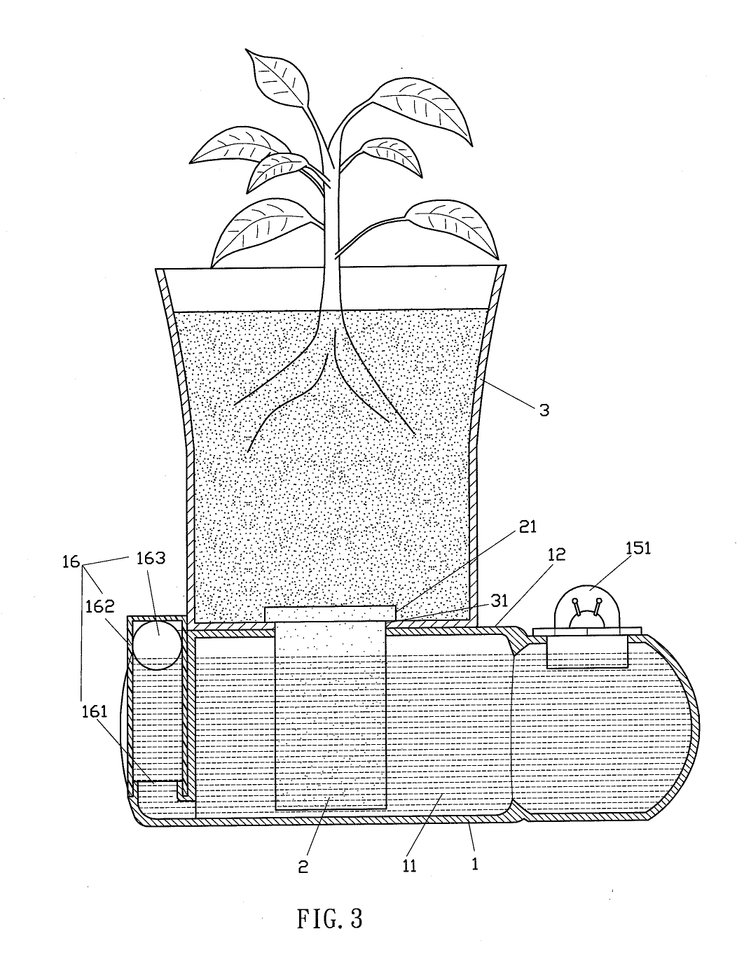

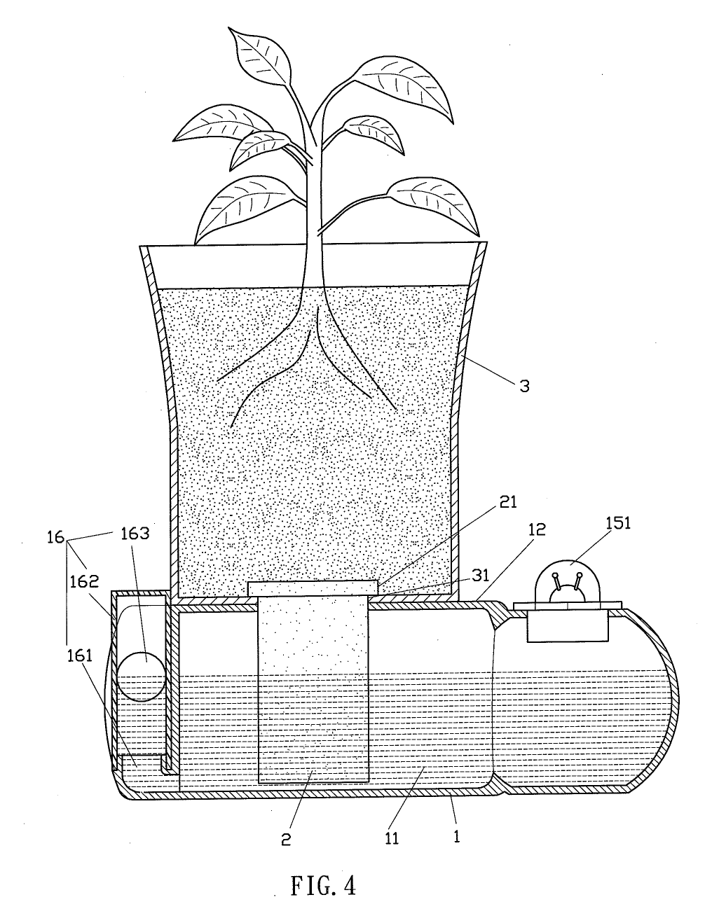

Referring to FIGS. 1 to 4, after adding water from the water flooding hole 15 into the holding space 11, the water flooding hole 15 is sealed by the cover 151. At this time, the ball 163 will ascend (as shown in FIG. 3) to show the current water level in the holding space 11; whereas, as the porous rod 2 is extended into water to transport water into soil in the plant pot 3 by the capillary action, keeping soil humid for a long time. After a period of time, the water level in the holding space 11 drops down and the ball 163 descends accordingly to remind the user to supplement water in time, preventing plant that is grown in the plant pot 3 from being withered.

In the abovementioned first embodiment, by using the cover 151 to seal the water flooding hole 15, the porous rod 2 to shield the through-hole 13, and the plant pot 3 to abut on the platform 12, the holding space 11 of the body 1 forms a non-open state, which is able to effectively prevent water in the holding space 11 from evaporating and dissipating, thereby maintaining a longer time for supplying water.

Besides, in the abovementioned first embodiment, the resist portion 21 of the porous rod 2 is in a circular shape. As the resist portion 21 is to prevent the porous rod 2 from escaping out of the plant pot 3, the resist portion 21 can be also in other shapes, such as a transversal rod or a bump.

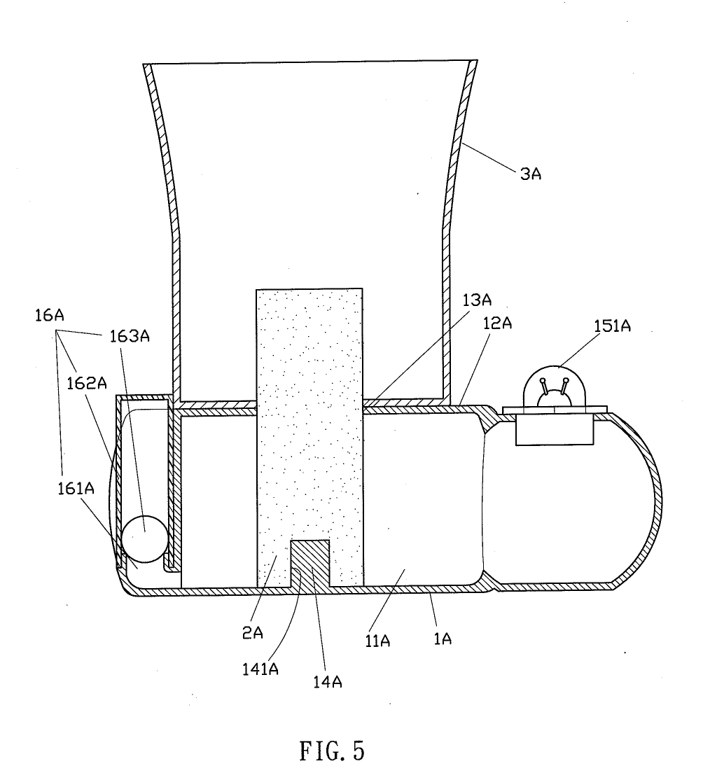

A second embodiment of the present invention is shown in FIG. 5. The second embodiment is also provided with a body 1A, a holding space 11A, a platform 12A, a cover 151A, an assembling port 161A, an outer tube 162A, a ball 163A and a porous rod 2A, and is implemented along with a plant pot 3A. Most structures are the same as those of the abovementioned first embodiment; therefore, no further description is disclosed. In the second embodiment, the porous rod 2A is not provided with the abovementioned resist portion, and the holding space 11A is provided with a fixing seat 14A at a bottom corresponding to the through-hole 13A; whereas, a bottom of the porous rod 2A is provided with a fixing slot 141A corresponding to the fixing seat 14A. By assembling the fixing seat 14A with the fixing slot 141A, the porous rod 2A can be fixed without being pulled away when the plant pot 3A is taken away. The fixing seat 14A can be assembled with the fixing slot 141A by other ways, not limited to that described in the second embodiment.

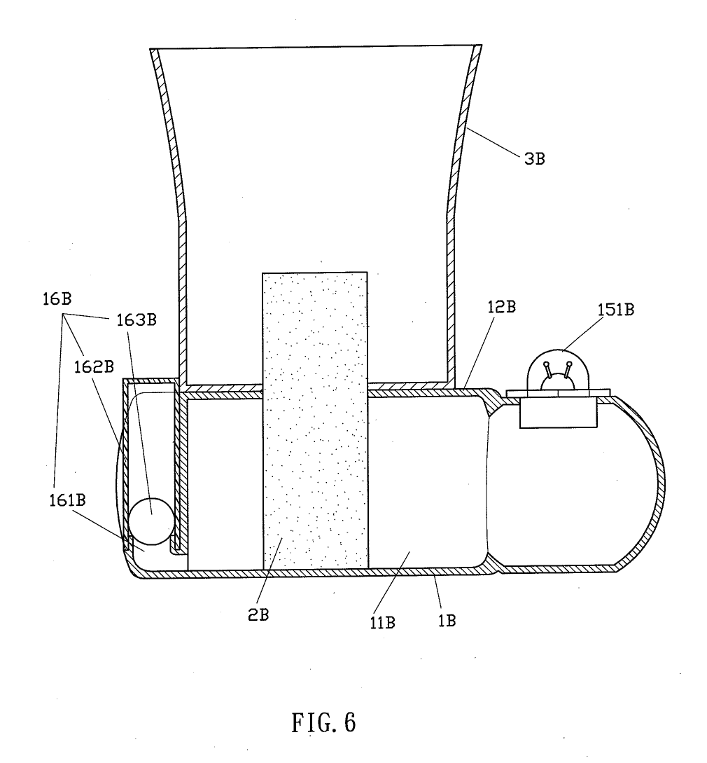

A third embodiment of the present invention is shown in FIG. 6. The third embodiment is also provided with a body 1B, a holding space 11B, a platform 12B, a cover 151B, an assembling port 161B, an outer tube 162B, a ball 163B and a porous rod 2B and is implemented along with a plant pot 3B. Most structures are the same as those of the first embodiment; therefore, no further description is disclosed. In the third embodiment, the porous rod 2B is fixed with the body 1B, wherein the body 1B is burned with pottery clay and the porous rod 2B is made by ceramic that can withstand higher temperature. In the process of burning the pottery clay, the porous rod 2B is embedded in advance, so that the body 1B, after being burned, can be assembled with the porous rod 2B integrally; whereas, the holding space 11B can be given a leak-proof effect by glazing a top surface of the body 1B.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A water supply base of a plant pot, comprising a body which is provided with a holding space to contain liquid and the body is provided with a platform to emplace a plant pot; and a porous rod which is extended into the holding space and protruded out of the platform.

2. The water supply base of a plant pot, according to claim 1, wherein the porous rod is integrally formed with the body.

3. The water supply base of a plant pot, according to claim 1, wherein the body is provided with a through-hole and a diameter of the through-hole is larger than that of the porous rod to transfix the porous rod.

4. The water supply base of a plant pot, according to claim 1, wherein the porous rod is hollow.

5. The water supply base of a plant pot, according to claim 1, wherein the porous rod is solid.

6. The water supply base of a plant pot, according to claim 1, wherein the holding space is provided with a fixing seat to fix the porous rod.

7. The water supply base of a plant pot, according to claim 1, wherein the body includes a water flooding hole and a plane height of the water flooding hole is lower than that of the platform.

8. The water supply base of a plant pot, according to claim 1, wherein the body includes a water level indication unit that is connected with the holding space.

9. The water supply base of a plant pot, according to claim 8, wherein the water level indication unit includes an outer tube that is connected with the holding space, and a ball that is located inside the outer tube.

10. The water supply base of a plant pot, according to claim 3, wherein the porous rod is transversally extended with a resist portion at a location where the porous rod is protruded out of the platform.
